(19) United States
(12) Patent Application Publication
(10) Pub. No.: US 2024/0347228 A1
(43) Pub. Date: Oct. 17, 2024

(54) SHIELDED ELECTRICAL CABLE

(71) Applicant: 3M INNOVATIVE PROPERTIES COMPANY, St. Paul, MN (US)

(72) Inventors: John T. Cowher, Austin, TX (US); Dennis L. Doye, Cedar Park, TX (US); Anthony R. Plepys, Concord, MA (US); James G. Vana, Cedar Park, TX (US)

(21) Appl. No.: 18/292,038

(22) PCT Filed: Jul. 11, 2022
(86) PCT No.: PCT/IB2022/056402

§ 371 Date: Jan. 25, 2024

Related U.S. Application Data
(60) Provisional application No. 63/226,830, filed on Jul. 29, 2021.

(51) Int. Cl. H01B 7/18; H01B 7/29; H01B 7/295; H01B 11/00

(52) U.S. Cl. CPC H01B 7/1875; H01B 7/292; H01B 7/295; H01B 11/002

(57) ABSTRACT

A shielded electrical cable is disclosed and includes a plurality of separate individual conductor sets. Each conductor set extends along a length of the cable and includes two or more insulated conductors, at least one uninsulated drain grounding wire, and electrically conductive first and second shielding films. The first and second shielding films include cover portions and pinched portions. Each pinched portion includes an edge extending along the length of the cable. An electrically conductive multilayer third shielding film is wrapped at least once around the plurality of separate individual conductor sets along the length of the cable and includes a substrate layer, an electrically conductive third shielding layer disposed on the substrate layer, and an intumescent layer disposed on the substrate layer and comprising an intumescent material.

### BACKGROUND

Data center communication cable assemblies can be shielded in a conductive metal layer in order to contain electromagnetic fields and prevent these fields from radiating into the external environment or interfering with other electrical elements. It is desirable for such cable assemblies to also be made from low Halogen content materials that exhibit flammability resistance and physical flexibility without detracting from its signal transmission performance.

### SUMMARY

In some aspects of the present disclosure, a shielded electric cable is disclosed. The shielded electrical cable can include a plurality of separate individual conductor sets, and each conductor set can extend along a length of the cable. Each conductor set can include two or more insulated conductors, at least one uninsulated drain grounding wire, and electrically conductive first and second shielding films disposed on opposite corresponding first and second sides of the conductor set. The first and second shielding films can include cover portions and pinched portions arranged such that, in a transverse cross-section, the cover portions of the first and second shielding films in combination substantially surround the conductor set, and the pinched portions of the first and second shielding films in combination form pinched portions of the conductor set on each side of the conductor set. Each pinched portion can include an edge extending along the length of the cable. An electrically conductive multilayer third shielding film can be wrapped at least once around the plurality of separate individual conductor sets along the length of the cable and can include a substrate layer, an electrically conductive third shielding layer disposed on the substrate layer, and an intumescent layer disposed on the substrate layer including an intumescent material. An electrically insulative braided sleeve can be disposed on the multilayer third shielding film along the length of the cable.

In some aspects of the present disclosure, a shielded electric cable is disclosed. The shielded electrical cable can include a plurality of separate individual conductor sets, each conductor set can extend along a length of the cable and can include two or more insulated conductors, at least one uninsulated drain grounding wire, and electrically conductive first and second shielding films disposed on opposite corresponding first and second sides of the conductor set. The first and second shielding films can include cover portions and pinched portions arranged such that, in a transverse cross-section, the cover portions of the first and second shielding films in combination substantially surround the conductor set, and the pinched portions of the first and second shielding films in combination form pinched portions of the conductor set on each side of the conductor set. Each pinched portion can include an edge extending along the length of the cable. An electrically conductive multilayer third shielding film can be wrapped at least once around the plurality of separate individual conductor sets along the length of the cable and can include a substrate layer, an electrically conductive third shielding layer disposed on the substrate layer, and an intumescent paint coated onto the at least once wrapped multilayer third shielding film. An electrically insulative braided sleeve can be disposed on the multilayer third shielding film along the length of the cable.

### BRIEF DESCRIPTION OF THE DRAWINGS

FIG. 1 is a perspective view of a conductor set according to exemplary embodiments of the present disclosure.

FIG. 2 is a cross sectional view of a first embodiment of a shielded electrical cable according to exemplary embodiments of the present disclosure.

FIG. 3 is a cross sectional view of a second embodiment of a shielded electrical cable according to exemplary embodiments of the present disclosure.

FIG. 4 is a cross sectional view of a third embodiment of a shielded electrical cable according to exemplary embodiments of the present disclosure.

FIG. 5 is perspective cross-sectional view of a folded electrically conductive multilayer third shielding film according to exemplary embodiments of the present disclosure.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

All scientific and technical terms used herein have meanings commonly used in the art unless otherwise specified. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

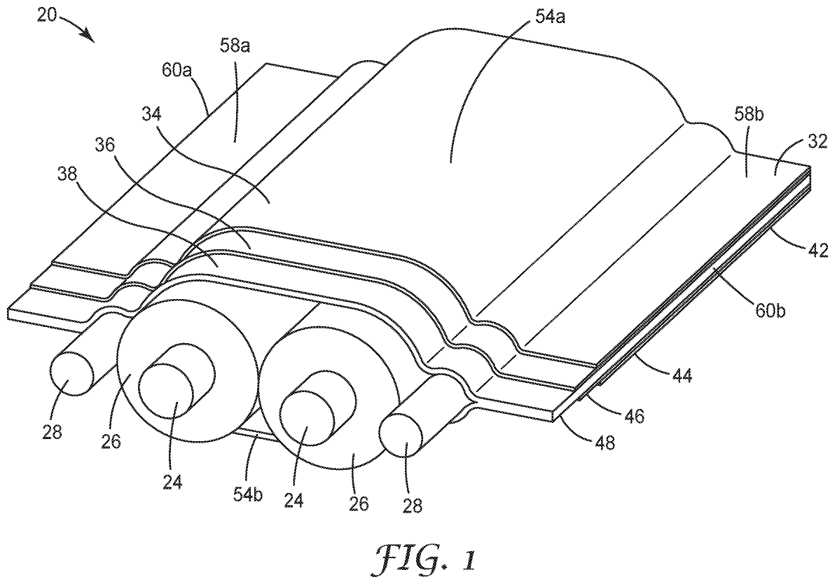

Turning to the figures, FIG. 1 is a perspective view of a conductor set 20 according to exemplary embodiments of the present disclosure. The conductor set 20 can include two insulated conductors, or conductors, 24 and two uninsulated drain grounding wires 28. The conductors 24 and/or uninsulated drain grounding wires 28 can include one or more electrically conductive material such as, but not limited to, a metal, a metal alloy, aluminum, gold, silver, copper, carbon, iron, steel, or any other suitable material commonly known to those skilled in the art. Insulating material 26, which can be called or include dielectric or a low loss dielectric material, can wholly or partially surround the conductors 24 and can extend along the length of the conductor set 20. The insulating material 26 can include one or more electrically insulating materials such as, but not limited to, plastics, polymers, dielectric materials, rubbers, organic materials, non-metals, polyolefins, polyimides, polyamides, polyesters, polyurethanes, fluoropolymers or any other suitable material known to those skilled in the art.

An average thickness of the insulating material 26 can be between about 100 μm and about 500 μm. In some embodiments, a wire diameter of each of the conductors 24 can be, can be about, can be at least, or can be at most, 20, 21, 22, 23, 24, 25, 26, 27, 28, 29, 30, 31, or 32 AWG. In some embodiments, a wire diameter of each of the conductors 24 can be between AWG 26 and AWG 30.

The conductor set 20 can also include a first shielding film 32, which can be called a first electrically conductive shielding film, and a second shielding film 42, which can be called a second electrically conductive shielding film. The first and second shielding films 32, 42 can wholly or partially surround one or more of the conductors 24, the insulating material 26, and the uninsulated drain grounding wires 28. In some embodiments, the first and second shielding films 32, 42 can be joined at pinched portions 58a, 58b and can also define cover portions 54a, 54b separated from one another. One or more of the conductors 24, the insulating material 26, and the uninsulated drain grounding wires 28 can be disposed between the cover portions 54a, 54b and between the pinched portions 58a, 58b, and thus surrounded by the first and second shielding films 32, 42 as shown in FIG. 1. Edges 60a, 60b can also be defined at extreme opposed lateral sides of the pinched portions 58a, 58b. In some embodiments, the edges 60a, 60b are not sealed. In various embodiments, cover portions 54a, 54b in combination substantially surround the conductor set 20 by encompassing at least 50%, 60%, 70%, 80%, 90%, or 95% of a periphery of the conductor set 20.

The first shielding film 32 can include a plurality of layers. In some embodiments, the first shielding film 32 can include a first barrier layer 34, a first shield layer 36, and a first adhesion layer 38. The first barrier layer 34 can include any substance that can provide a barrier between the first shield layer 36 and an exterior of the conductor set 20 and can include one or more materials such as, but not limited to, plastics, polymers, rubbers, organic materials and non-metals. In some embodiments, the first barrier layer 34 can include Polyethylene Terephthalate (PET). Further, in some embodiments, the first barrier layer 34 can have a thickness of, of about, of at least, or of at most: 0.0001, 0.0002, 0.0003, 0.0004, 0.0005, 0.0006, 0.0007, 0.0008, 0.0009, or 0.001 inches. Further, in various embodiments, the first barrier layer 34 can define a thickness of 0.00048 inches or of 0.00048+/−0.00004 inches.

The first shield layer 36 can include one or more electrically conductive materials such as, but not limited to, a metal, a metal alloy, aluminum, gold, silver, copper, carbon, iron, steel, or any other suitable material commonly known to those skilled in the art. In some embodiments, the first shield layer 36 can have a thickness of, of about, of at least, or of at most: 0.00005, 0.00006, 0.00007, 0.00008, 0.00009, 0.0001, 0.0002, 0.0003, 0.0004, 0.0005, 0.0006, 0.0007, 0.0008, 0.0009, or 0.001 inches. Further, in various embodiments, the first shield layer 36 can define a thickness of 0.000285 inches or of 0.000285+/−0.000014 inches.

The first adhesion layer 38 can include any suitable adhesive known to those skilled in the art. In various embodiments, the first adhesion layer 38 can be a hotmelt adhesive. In some embodiments, the first adhesion layer 38 can include polyethylene. In some embodiments, the first adhesion layer 38 can have a thickness of, of about, of at least, or of at most: 0.0005, 0.0006, 0.0007, 0.0008, 0.0009, 0.001, 0.002, 0.003, 0.004, 0.005, 0.006, 0.007, 0.008, 0.009, or 0.01 inches. Further, in various embodiments, the first adhesion layer 38 can define a thickness of 0.001 inches or of 0.001+/−0.00015 inches.

In the first shielding film, the first adhesion layer 38, the first shield layer 36 and the first barrier layer 34 can be disposed sequentially, as shown in FIG. 1, with the first adhesion layer 38 disposed radially-inwardly of the other two layers 36, 34 in the conductor set 20 and with the first barrier layer 34 disposed radially-outwardly of the other two layers 36, 38 in the conductor set 20. In some embodiments, various adjacent layers (34 and 36, and 36 and 38) can contact one another. In some embodiments, an adhesive can be disposed between the first barrier layer 34 and the first shield layer 36 and/or between the first shield layer 36 and the first adhesion layer 38. In various embodiments, each of the conductors 24 of each of the conductor sets 20 has a nominal differential characteristic impedance in a range of between about 40 and about 60 ohms, between about 45 and about 55 ohms, between about 70 and 110 ohms, or between about 80 and about 100 ohms. In some embodiments, each of the conductors 24 of each of the conductor sets 20 has a nominal differential characteristic impedance in a range of between about 70 and about 120 ohms. Further, each conductor set 20 can comprise an insertion loss Sdd21 for a differential mode and an insertion loss Scd21 for a conversion of a differential mode to a common mode, such that when the shielded electrical cable 10, 11, 12 is bent 180° around a 0.50″ diameter mandrel for AWG30 16 pair cable Scd21-Sdd21 of the shielded electrical cable 10, 11, 12 increases by less than about 5 dB as compared to an unbent configuration.

The electrically conductive second shielding film 42 can include a second barrier layer 44, a second shield layer 46, and a second adhesion layer 48, as can be seen in FIG. 1. It is to be understood that the electrically conductive second shielding film 42 can have similar or identical features or properties as the electrically conductive first shielding film 32, while the second barrier layer 44, a second shield layer 46, and second adhesion layer 48 can have similar or identical features or properties as the first barrier layer 34, first shield layer 36, and first adhesion layer 38, respectively.

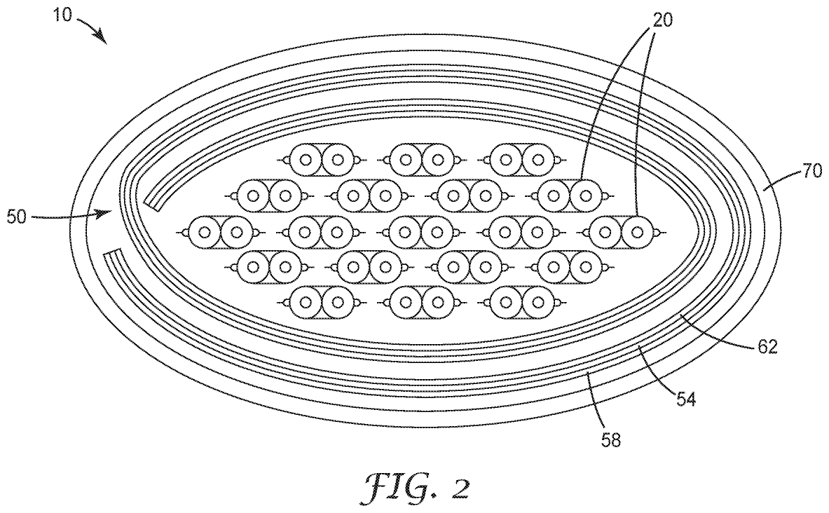

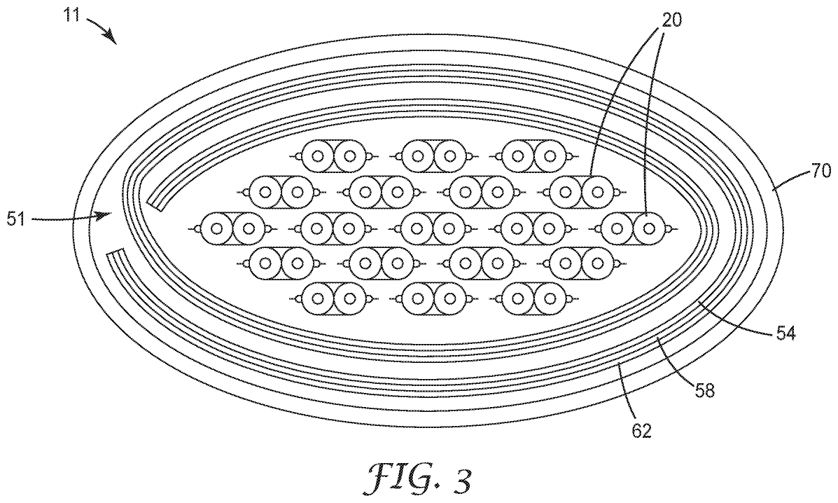

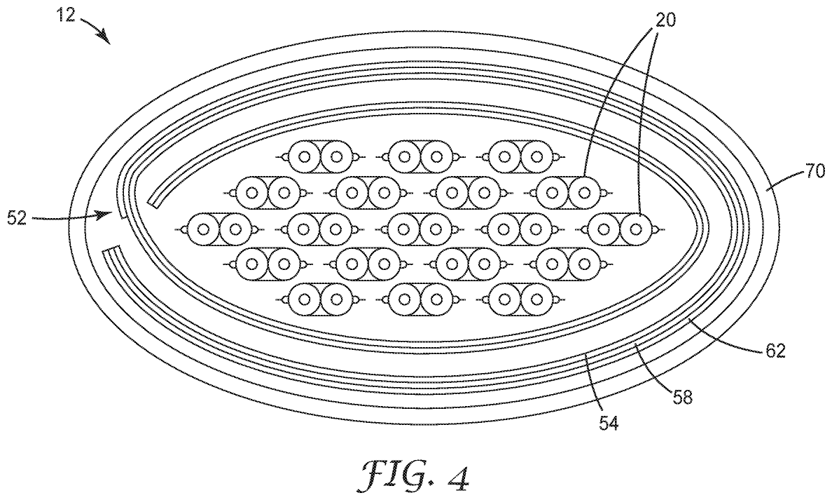

FIG. 2 is a cross sectional view of a first embodiment of a shielded electrical cable 10, FIG. 3 is a cross sectional view of a second embodiment of a shielded electrical cable 11, and FIG. 4 is a cross sectional view of a third embodiment of a shielded electrical cable 12 according to exemplary embodiments of the present disclosure. Turning first to the embodiment shown in FIG. 2, the shielded electrical cable 10 can include an electrically conductive multilayer third shielding film 50, one or more conductor sets 20, and an electrically insulative braided sleeve 70. The sleeve 70 can include a polyester, nylon, polyimide, poly(p-phenylene terephthalamide), glass fiber and/or can be an Expando sleeve. The conductor sets 20 can be similar to, or identical to, the conductor set 20 shown in FIG. 1. In some embodiments, the shielded electrical cable 10 can include at least 2, 4, 6, 8, or 10 conductor sets 20. In various embodiments, the shielded electrical cable 10 can have a transverse round, circular, oval, or elliptical cross section.

The electrically conductive multilayer third shielding film 50 can include a substrate layer 54, a third shielding layer 58, and an intumescent layer 62. In some embodiments, the intumescent layer 62 can include, or can be comprised of, an intumescent material having properties that cause it to expand (or intumesce) when exposed to high temperatures and/or to fire. In various embodiments, the intumescent material can expand to, to about, to at most, or to at least: 1.1, 1.2, 1.3, 1.4, 1.5, 1.6, 1.7, 1.8, 1.9, 2.0, 2.25, 2.5, 2.75, or 3.0 times its original size when exposed to high temperatures, to fires, to fire-like conditions, and/or to temperatures of at least 500, 750, 1000, 1250, 1500, 1750, or 2000 degrees Celsius.

In various embodiments, the intumescent material (or intumescent layer 62) can include 3M™ FireDam™ 2000, DC310 Cable Coating, an ammonium polyphosphate, a pentaerythritol, a melamine, and/or an intercalated graphite. The intumescent material (or the intumescent layer 62) can also include an intumescent paint coated onto one or more of the substrate layer 54 and the third shielding layer 58. In some embodiments, when exposed to one or more of the environmental conditions described above, the intumescent material can produce a char, or a light char. The light char can be a poor heat conductor and thus protect elements of the shielded electrical cable 10 from the high temperatures by limiting heat transfer across light char. The light char can consist of a microporous carbonaceous foam formed by a chemical reaction of various materials, such as ammonium polyphosphate, pentaerythritol, and melamine. Additionally, expansion pressure created in these reactions is generally low, which can be advantageous when the intumescent material is an element within a product construction. An average thickness of the intumescent layer 62 can be between about 25 and 300 microns.

The substrate layer 54 can include any suitable substrate known to those skilled in the art. In some embodiments, the substrate layer 54 can include Polyethylene Terephthalate (PET), or any other suitable polymer or material such as a thin film, LG1047 Shielding Tape, metal/PET laminates, aluminum/PET laminates, acrylates, methacrylates, polyurethanes, polyesters, urethanes, polycarbonates, non-intumescent materials, polysiloxanes, polyimides, and/or polyolefins. The third shielding layer 58 can include any electrically conductive material commonly known to those skilled in the art such as, but not limited to, a metal, a metal alloy, aluminum, gold, silver, copper, carbon, iron, or steel.

As can be seen in FIG. 2, the electrically conductive multilayer third shielding film 50 can be wrapped around the conductor sets 20 and can further be disposed within the electrically insulative braided sleeve 70. In various embodiments, the electrically conductive multilayer third shielding film 50 can be wrapped around the conductor sets 20 once, more than once, twice, more than twice, three times, or more than three times. Further, the electrically conductive multilayer third shielding film 50 can be helically wrapped around the conductor sets 20 along the length of the shielded electrical cable 10 or can be helically and overlappingly wrapped around the conductor sets 20 along the length of the shielded electrical cable 10. In various embodiments, the electrically conductive multilayer third shielding film 50 is longitudinally wrapped around the individual conductor sets 20 so that opposing longitudinal edges of the electrically conductive multilayer third shielding film 50 overlap to form an overlap seam along the length of the shielded electrical cable 10. An average thickness of the electrically conductive multilayer third shielding film 50 can be between about 75 and about 350 microns.

As can also be seen in FIG. 2, the substrate layer 54 can be disposed between the third shielding layer 58 and the intumescent layer 62 within the electrically conductive multilayer third shielding film 50. Further, the third shielding layer 58 can be disposed radially outwardly of the substrate layer 54 and/or the substrate layer 54 can be disposed radially outwardly of the intumescent layer 62 when the electrically conductive multilayer third shielding film 50 is wrapped around the conductor sets 20. In some embodiments, an adhesive joins the third shielding layer 58 and the substrate layer 54, and in some embodiments an adhesive joins the intumescent layer 62 and the substrate layer 54. In various embodiments, the third shielding layer 58 can be disposed on, or be in contact with, the substrate layer 54 and the substrate layer 54 can be disposed on, or be in contact with, the intumescent layer 62. Further, the electrically insulative braided sleeve 70 can be disposed on, or be in contact with, the third shielding layer 58.

In various embodiments, any electrical connection between the third shielding layer 58 and the at least one uninsulated drain grounding wire 28 of each of the conductor sets 20 is only a capacitive connection.

Turning now to the embodiment shown in FIG. 3, the shielded electrical cable 11 can include an electrically conductive multilayer third shielding film 51, one or more conductor sets 20, and the electrically insulative braided sleeve 70. The conductor sets 20 can be similar to, or identical to, the conductor set 20 shown in FIG. 1. In some embodiments, the shielded electrical cable 11 can include at least 2, 4, 6, 8, or 10 conductor sets 20. In various embodiments, the shielded electrical cable 11 can have a transverse round, circular, oval, or elliptical cross section.

The electrically conductive multilayer third shielding film 51 can include the substrate layer 54, the third shielding layer 58, and the intumescent layer 62. As can be seen in FIG. 3, the electrically conductive multilayer third shielding film 51 can be wrapped around the conductor sets 20 and can further be disposed within the electrically insulative braided sleeve 70. In various embodiments, the electrically conductive multilayer third shielding film 51 can be wrapped around the conductor sets 20 once, more than once, twice, more than twice, three times, or more than three times. Further, the electrically conductive multilayer third shielding film 51 can be helically wrapped around the conductor sets 20 along the length of the shielded electrical cable 11 or can be helically and overlappingly wrapped around the conductor sets 20 along the length of the shielded electrical cable 11. In various embodiments, the electrically conductive multilayer third shielding film 51 is longitudinally wrapped around the individual conductor sets 20 so that opposing longitudinal edges of the electrically conductive multilayer third shielding film 51 overlap to form an overlap seam along the length of the shielded electrical cable 11. An average thickness of the electrically conductive multilayer third shielding film 51 can be between about 75 and about 350 microns.

As can also be seen in FIG. 3, the third shielding layer 58 can be disposed between the substrate layer 54 and the intumescent layer 62 within the electrically conductive multilayer third shielding film 51. Further, the intumescent layer 62 can be disposed radially outwardly of the third shielding layer 58 and/or the third shielding layer 58 can be disposed radially outwardly of the substrate layer 54 when the electrically conductive multilayer third shielding film 51 is wrapped around the conductor sets 20. In some embodiments, an adhesive joins the third shielding layer 58 and the substrate layer 54, and in some embodiments an adhesive joins the intumescent layer 62 and the third shielding layer 58. In various embodiments, the third shielding layer 58 can be disposed on, or be in contact with, the substrate layer 54 and the third shielding layer 58 can be disposed on, or be in contact with, the intumescent layer 62. Further, the electrically insulative braided sleeve 70 can be disposed on, or be in contact with, the intumescent layer 62.

Turning now to the embodiment shown in FIG. 4, the shielded electrical cable 12 can include an electrically conductive multilayer third shielding film 52, one or more conductor sets 20, and the electrically insulative braided sleeve 70. The conductor sets 20 can be similar to, or identical to, the conductor set 20 shown in FIG. 1. In some embodiments, the shielded electrical cable 12 can include at least 2, 4, 6, 8, or 10 conductor sets 20. In various embodiments, the shielded electrical cable 12 can have a transverse round, circular, oval, or elliptical cross section.

The electrically conductive multilayer third shielding film 52 can include the substrate layer 54, the third shielding layer 58, and the intumescent layer 62. As can be seen in FIG. 4, the electrically conductive multilayer third shielding film 52 can be wrapped around the conductor sets 20 and can further be disposed within the electrically insulative braided sleeve 70. In various embodiments, the electrically conductive multilayer third shielding film 52 can be wrapped around the conductor sets 20 once, more than once, twice, more than twice, three times, or more than three times. Further, the electrically conductive multilayer third shielding film 52 can be helically wrapped around the conductor sets 20 along the length of the shielded electrical cable 12 or can be helically and overlappingly wrapped around the conductor sets 20 along the length of the shielded electrical cable 12. In various embodiments, the electrically conductive multilayer third shielding film 52 is longitudinally wrapped around the individual conductor sets 20 so that opposing longitudinal edges of the electrically conductive multilayer third shielding film 52 overlap to form an overlap seam along the length of the shielded electrical cable 12. An average thickness of the electrically conductive multilayer third shielding film 52 can be between about 75 and about 350 microns.

As can also be seen in FIG. 4, the third shielding layer 58 can be disposed between the substrate layer 54 and the intumescent layer 62 within the electrically conductive multilayer third shielding film 52. Further, the intumescent layer 62 can be disposed radially outwardly of the third shielding layer 58 and/or the third shielding layer 58 can be disposed radially outwardly of the substrate layer 54 when the electrically conductive multilayer third shielding film 52 is wrapped around the conductor sets 20. In some embodiments, an adhesive joins the third shielding layer 58 and the substrate layer 54, and in some embodiments an adhesive joins the intumescent layer 62 and the third shielding layer 58. In various embodiments, the third shielding layer 58 can be disposed on, or be in contact with, the substrate layer 54 and the third shielding layer 58 can be disposed on, or be in contact with, the intumescent layer 62. Further, the electrically insulative braided sleeve 70 can be disposed on, or be in contact with, the intumescent layer 62. In the embodiment of FIG. 4, it can be seen that the intumescent layer 62 does not extend fully around the electrically conductive multilayer third shielding film 52 as the electrically conductive multilayer third shielding film 52 wraps around the conductor sets 20. Instead, the intumescent layer 62 is wrapped substantially once around the conductor sets 20 while the remainder of the electrically conductive multilayer third shielding film 52 (the substrate layer 54 and the third shielding layer 58) continue to wrap around the conductor sets 20.

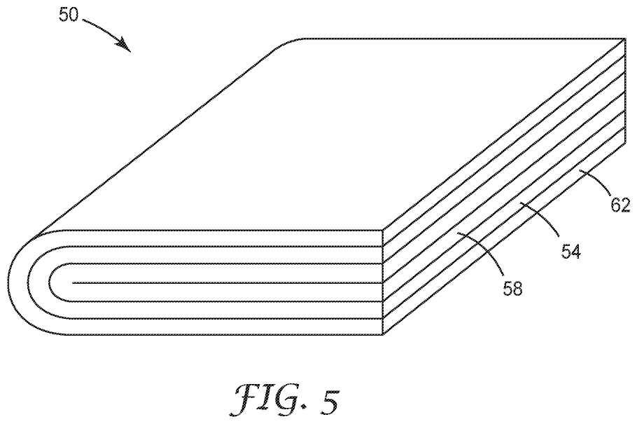

FIG. 5 is perspective cross-sectional view of a folded electrically conductive multilayer third shielding film 50 according to exemplary embodiments of the present disclosure. As shown, the electrically conductive multilayer third shielding film 50 can be folded such that the intumescent layer 62 (and intumescent material) is disposed on both the upper and lower surfaces of the folded electrically conductive multilayer third shielding film 50. Additionally, a folded edge and an open edge can be formed. The folded electrically conductive multilayer third shielding film 50 can be wrapped around the conductor sets 20, in any of the above-described manners, such that the open edge does not contact any of the separate individual conductor sets 20. In some embodiments, the open edge can be substantially wrapped around the folded edge. Thus, in the embodiments described with respect to FIG. 5, the open edge may not contact and/or may not be proximate any portion of the conductor sets 20, leading to enhanced electrical stability and reliability of the shielded electrical cable 10 by limiting or preventing electrical communication between the open end and the conductor sets 20.

In operation, embodiments of the current disclosure provide numerous novel and non-obvious benefits over the art. The combination of the intumescent material and the low dielectric materials (such as the first and second barrier layers, the first and second adhesion layers, the insulating material, and/or the substrate layer) enables a shielded electrical cable having both excellent electrical properties as well as excellent performance in the face of fire or high temperatures. Additionally, the electrically conductive multilayer third shielding film, as well as the disclosed arrangement of conductor sets wrapped within the electrically conductive multilayer third shielding film, provides an innovative and convenient technology for disposing and securing conductor sets within a shielded electrical cable while maintaining electrical performance and resistance to fires and high temperatures. Other benefits are also envisioned.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 5 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.95 and 1.05, and that the value could be 1.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A shielded electrical cable comprising:
a plurality of separate individual conductor sets, each conductor set extending along a length of the cable and comprising:
two or more insulated conductors;
at least one uninsulated drain grounding wire; and
electrically conductive first and second shielding films disposed on opposite corresponding first and second sides of the conductor set, the first and second shielding films including cover portions and pinched portions arranged such that, in a transverse cross-section, the cover portions of the first and second shielding films in combination substantially surround the conductor set, and the pinched portions of the first and second shielding films in combination form pinched portions of the conductor set on each side of the conductor set, each pinched portion comprising an edge extending along the length of the cable;
an electrically conductive multilayer third shielding film wrapped at least once around the plurality of separate individual conductor sets along the length of the cable and comprising:
a substrate layer;
an electrically conductive third shielding layer disposed on the substrate layer; and
an intumescent layer disposed on the substrate layer or the electrically conductive third shielding layer and comprising an intumescent material; and
an electrically insulative braided sleeve disposed on the multilayer third shielding film along the length of the cable.

2. The shielded electrical cable of claim 1, wherein each conductor set comprises two insulated conductors and two uninsulated drain grounding wires disposed on opposite lateral sides of the two insulated conductors.

3. The shielded electrical cable of claim 1, wherein the plurality of separate individual conductor sets comprises at least four conductor sets.

4. The shielded electrical cable of claim 1, wherein a wire diameter of each of the insulated conductors of each of the conductor sets is between AWG 26 and AWG 30.

5. The shielded electrical cable of claim 1, wherein any electrical connection between the third shielding film and the at least one uninsulated drain grounding wire of each of the conductor sets is only a capacitive connection.

6. The shielded electrical cable of claim 1, wherein each of the insulated conductors of each of the conductor sets has a nominal characteristic impedance in a range of between about 40 and about 60 ohms.

7. The shielded electrical cable of claim 1, wherein each of the insulated conductors of each of the conductor sets has a nominal differential characteristic impedance in a range of between about 70 and about 120 ohms.

8. The shielded electrical cable of claim 1, wherein each of the first and second shielding films comprises one or more of copper, aluminum, and silver.

9. The shielded electrical cable of claim 1, wherein the edges of each of the conductor sets is not sealed.

10. The shielded electrical cable of claim 1, wherein the cover portions of the first and second shielding films of each conductor set in combination substantially surround the conductor set by encompassing at least 70% of a periphery of the conductor set.

11. The shielded electrical cable of claim 1 having a transverse round cross-section.

12. The shielded electrical cable of claim 1 having a transverse circular cross-section.

13. The shielded electrical cable of claim 1 having a transverse oval cross-section.

14. The shielded electrical cable of claim 1 having a transverse elliptical cross-section.

15. The shielded electrical cable of claim 1, wherein each of the two or more insulated conductors comprises a central conductor surrounded by a dielectric material.

16. The shielded electrical cable of claim 15, wherein the dielectric material comprises one or more of a polyolefin and a fluoropolymer.

17. The shielded electrical cable of claim 15, wherein an average thickness of the dielectric material is between about 100 μm and about 500 μm.

18. The shielded electrical cable of claim 1, wherein the third shielding film is helically wrapped around the plurality of separate individual conductor sets along the length of the cable.

19. The shielded electrical cable of claim 18, wherein the third shielding film is helically and overlappingly wrapped around the plurality of separate individual conductor sets along the length of the cable.

20. The shielded electrical cable of claim 1, wherein the third shielding film is longitudinally wrapped around the plurality of separate individual conductor sets so that opposing longitudinal edges of the third shielding film overlap to form an overlap seam along the length of the cable.

21.-39. (canceled)
